(19) United States
(12) Patent Application Publication
(10) Pub. No.: US 2011/0233234 A1
(43) Pub. Date: Sep. 29, 2011

(54) CONTAINER APPARATUS FOR DISPENSING LIQUIDS

(75) Inventors: Reinie Drygala, Mississauga (CA); Stuart Werle, Toronto (CA); Edmond Rampen, Burlington (CA)

(73) Assignee: Suncor Energy Inc., Calgary (CA)

(21) Appl. No.: 12/749,450

(22) Filed: Mar. 29, 2010

(51) Int. Cl. B67D 7/60

(52) U.S. Cl. 222/383.1; 222/377; 222/333

(57) ABSTRACT

A container and container apparatus for dispensing liquids is disclosed. The container apparatus includes a body defining a reservoir for holding a liquid, and a neck extending outwardly from the body and providing a handgrip portion, which when grasped by a user's hand such that the reservoir is disposed generally below the user's hand, defines an upright operating condition for the container. The container also includes a sprayer disposed at a distal end of the neck, the sprayer having an intake and a nozzle, the intake being in communication with the reservoir for drawing liquid from the reservoir, the nozzle being disposed such that when the container is oriented in the upright operating condition, liquid is discharged from the nozzle in a discharge direction oriented downwardly at a discharge angle of in the range of about 10 degrees to about 30 degrees to a notional horizontal line extending outwardly from the nozzle.

### BACKGROUND OF THE INVENTION

1. Field of Invention

This invention relates generally to a container for dispensing liquids and more particularly to a container for dispensing liquids using a sprayer.

2. Description of Related Art

Containers having a sprayer for dispensing liquid toward a target are commonly used for dispensing liquid cleaning formulations, herbicides, pesticides, and a variety of other liquids used in household, commercial and industrial applications. Some applications require extended manual operation of the actuator by a user's hand over a period of time, which may result in hand or wrist fatigue. One such application is the treatment of garden weeds using a spray bottle. For example, when treating weeds in a lawn area using a selective herbicide, the user may need to dispense a spray or stream of herbicide onto target weeds over a large area of lawn. Many spray bottles include manually actuated trigger sprayers requiring repetitive actuation of the trigger to discharge the herbicide while simultaneously cocking the wrist to aim the spray or stream at the target weed, which often results in the user experiencing hand and wrist fatigue well before all of the weeds have been treated.

Accordingly, there remains a need for improved containers for dispensing liquids.

### SUMMARY OF THE INVENTION

In accordance with one aspect of the invention there is provided a container apparatus for dispensing liquids. The apparatus includes a body defining a reservoir for holding a liquid, and a neck extending outwardly from the body and providing a handgrip portion, which when grasped by a user's hand such that the reservoir is disposed generally below the user's hand, defines an upright operating condition for the container. The container also includes a sprayer disposed at a distal end of the neck, the sprayer having an intake and a nozzle, the intake being in communication with the reservoir for drawing liquid from the reservoir, the nozzle being disposed such that when the container is oriented in the upright operating condition, liquid is discharged from the nozzle in a discharge direction oriented downwardly at a discharge angle of in the range of about 10 degrees to about 30 degrees to a notional horizontal line extending outwardly from the nozzle.

The distal end of the neck may be angled forward sufficiently toward the discharge direction to cause the nozzle to be disposed to discharge liquid in the discharge direction when the container is oriented in the upright operating condition.

The neck may form an opening at the distal end of the neck for removably receiving the sprayer.

The body may form an opening for removably receiving the neck.

The body may include a base and a plurality of walls extending upwardly from the base, and the base may be substantially horizontally oriented when the container is oriented in the upright operating condition.

The discharge angle may be in the range of about 20 degrees.

The discharge angle may be in the range of about 15 degrees to about 25 degrees.

The sprayer may include a reciprocating piston pump coupled to a manual trigger actuator, the actuator being operable to cause the pump to expel liquid through the nozzle when the actuator is depressed and to draw liquid from the reservoir when the actuator is released.

The sprayer may include an electrical pump operably configured to cause liquid to be drawn up from the reservoir and expelled through the nozzle when actuated.

The neck may define a conduit extending between the sprayer and the body and the intake of the sprayer may include a tube extending through the conduit and terminating in an inlet end in communication with the reservoir.

The tube may include a flexible tube having a length selected to cause the inlet end of the tube to be forced forwardly in the reservoir toward the dispensing direction such that when the container is tilted forward from the generally upright condition, the inlet end of the tube is disposed to draw liquid from a low point in the reservoir.

The body may include a base and a plurality of walls extending upwardly from the base and the length of the tube may be at least about 10% longer than a minimum dimension between the sprayer and the base.

The body may include a base and a plurality of walls extending upwardly from the base and the inlet end of the tube may be disposed proximate an intersection between the base and a wall defining a side of the container oriented toward the dispensing direction.

The handgrip portion may extend upwardly from a location on the body that is disposed to cause a center of mass of the liquid in the reservoir to be located generally vertically below the user's hand thereby preventing the mass of the liquid in the reservoir from exerting a torque on the user's wrist during operation in the upright operating condition and reducing the torque exerted on the user's wrist when the wrist is cocked to aim the discharge direction toward or away from the user.

The neck may include a protrusion oriented in the dispensing direction and disposed to cause a little finger and ring finger of the user to be located generally between the body and the protrusion when grasping the handgrip portion of the neck.

The neck may include at least one surface having a plurality of relief features extending over at least a portion of the handgrip portion.

The relief features may be formed by a plurality of raised features.

The relief features may be formed by a plurality of recessed features.

In accordance with another aspect of the invention there is provided a container apparatus. The apparatus includes a body defining a reservoir for holding a liquid, and a neck extending outwardly from the body and providing a handgrip portion, which when grasped by a user's hand such that the reservoir is disposed generally below the user's hand, defines an upright operating condition for the container. The neck forms an opening at a distal end of the neck for receiving a sprayer, the sprayer having an intake and a nozzle such that when the nozzle is received in the opening, the intake is disposed in communication with the reservoir for drawing liquid from the reservoir, and when the container is oriented in the upright operating condition the nozzle is disposed such that liquid is discharged from the nozzle in a discharge direction oriented downwardly at a discharge angle of in the range of about 10 degrees to about 30 degrees to a notional horizontal line extending outwardly from the nozzle.

Other aspects and features of the present invention will become apparent to those ordinarily skilled in the art upon review of the following description of specific embodiments of the invention in conjunction with the accompanying figures.

### BRIEF DESCRIPTION OF. THE DRAWINGS

In drawings which illustrate embodiments of the invention,

FIG. 1 is a side view of a container in accordance with a first embodiment of the invention;

FIG. 2 is a partially cut away side view of the container shown in FIG. 1 including an actuator;

FIG. 3 is a side view of the container and actuator shown in FIG. 2 showing one possible mode of operation;

FIG. 4 is a further side view of the container and actuator shown in FIG. 2 showing an alternatively mode of operation; and

FIG. 5 is partially cut away side view of a container and actuator in accordance with an alternative embodiment of the invention.

### DETAILED DESCRIPTION

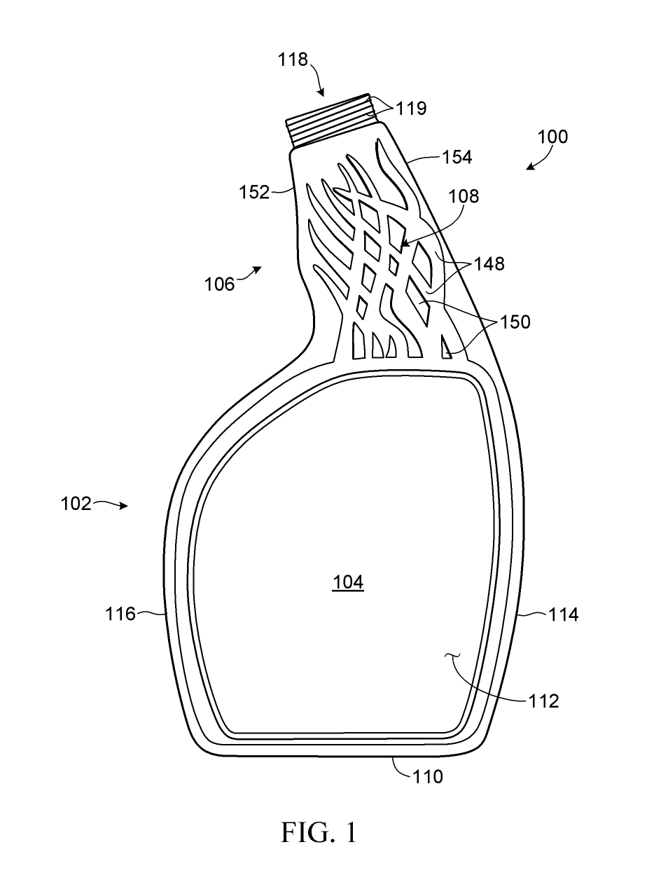

Referring to FIG. 1, a container according to a first embodiment of the invention is shown generally at 100. The container 100 includes a body 102 defining a reservoir 104 for holding a liquid. The container 100 also includes a neck 106 extending outwardly from the body 102. The neck 106 defines a handgrip portion 108, which is shaped to receive a user's hand. The neck 106 is generally tubular and forms and opening 118 at a distal end of the neck. The opening 118 has a threaded portion 119 for removably receiving a sprayer.

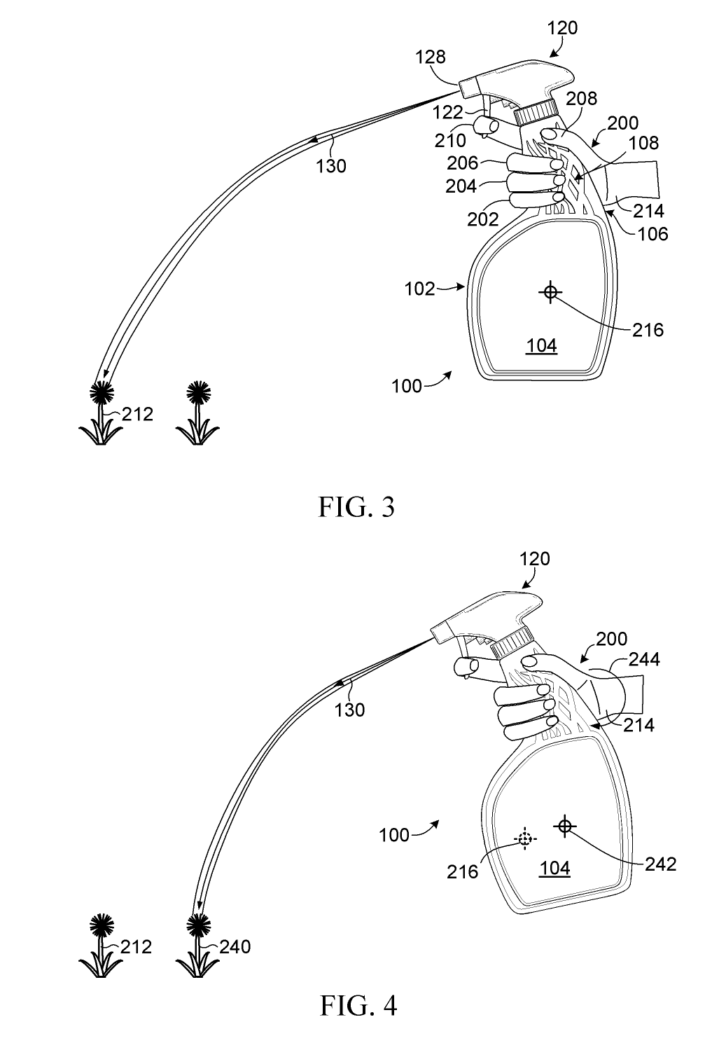

The container 100 is shown in FIG. 1 in an upright operating condition, in which when grasped by the user's hand as shown in FIG. 3, the container is oriented such that the reservoir 104 is disposed generally below the user's hand. In this embodiment, the body 102 is defined by a base 110 and a plurality of upwardly extending walls (where walls 112, 114, and 116 are visible in FIG. 1). In the embodiments depicted herein, the base 110 is generally horizontally oriented when the container 100 is in the upright operating condition. However, in other embodiments the base of the container may be otherwise oriented with respect to the body causing the base to be inclined when the container is in the upright operating condition. The body 102 and neck 106 may be molded from plastic to form an integral container 100.

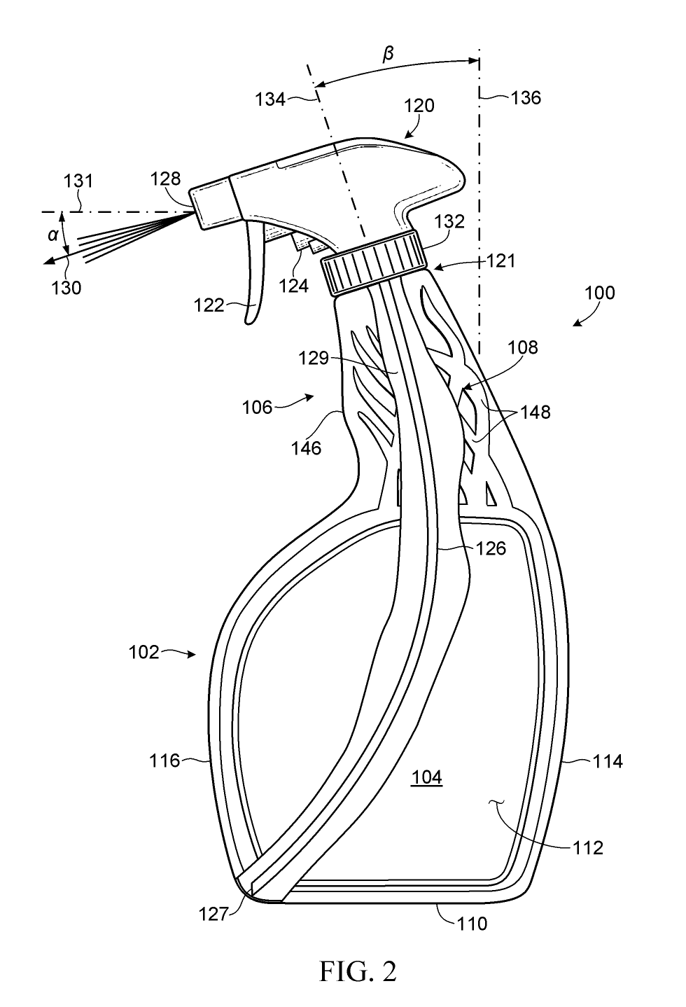

The container 100 is shown in FIG. 2 with a sprayer 120 in place in the opening 118. Referring to FIG. 2, the sprayer 120 is disposed at a distal end 121 of the neck 106. In this embodiment the sprayer 120 includes a threaded ring 132 for removably engaging the threaded portion 119 of the opening 118 (shown in FIG. 1). However, in other embodiments the sprayer 120 may secured in place by gluing, plastic welding, or snap fitting the sprayer into the opening 118. The neck 106 defines a conduit 129 extending through the handgrip portion between the reservoir 104 and the opening 118. The sprayer 120 includes an intake tube 126, which extends through the conduit 129 and has an inlet end 127 in communication with the reservoir 104 for drawing liquid from the reservoir.

The sprayer 120 also includes a nozzle 128, which is disposed such that when the container 100 is oriented in the upright operating condition as shown, liquid is discharged from the nozzle in a discharge direction 130. The discharge direction 130 is oriented downwardly at a discharge angle α of in the range of about 10° to about 30° to a notional horizontal line 131 extending outwardly from the nozzle 128.

In this embodiment the sprayer 120 comprises a conventional trigger-style sprayer having a trigger 122 for activating a pump 124. The pump 124 is in communication with the intake tube 126 and may be configured as a reciprocating piston pump. In a conventional reciprocating piston pump, a trigger is coupled to a piston and a spring acts on the trigger or piston to bias the trigger outwardly with respect to the sprayer. Each time the trigger is depressed against the bias force provided by the spring, liquid is discharged through the nozzle 128. When the trigger is subsequently released, the spring causes the pump to draw liquid up through the intake tube 126. The discharged liquid may be discharged as a mist, spray, or stream pattern depending on a configuration of the nozzle. Many sprayers are provided with an adjustable nozzle that facilitates user selection of a desired discharge pattern.

In the embodiment shown, the distal end 121 of the neck 106 is angled forward toward the discharge direction 130 by an angle β. In FIG. 2, the orientation of the neck 106 is represented by an axis line 134, and the angle β is defined with respect to a notional vertical line 136. The angled neck 106 thus disposes the nozzle 128 for discharge of liquid in the discharge direction 130 when the container is oriented in the upright operating condition. In this embodiment, the sprayer 120 is configured to discharge liquid in a direction (130) that is substantially perpendicular to the axis line 134 and as such, the angle α is defined by the neck angle β and these angles both have the same magnitude. However, in other embodiments the sprayer 120 may be configured to discharge liquid in a direction other than perpendicular to the axis line 134 and the neck 106 may be angled to a lesser or greater degree. Accordingly, the discharge angle α and the neck angle β may have different magnitudes. For example, the neck may be vertically oriented (i.e. aligned with the notional vertical line 136 such that β=0°) and the sprayer 120 may be configured to discharge liquid in a direction that is angled to the axis line 134 by an angle of (90°−α) to provide the desired discharge direction 130 at a discharge angle of α.

Referring to FIG. 3, the container 100 is depicted under operational conditions with a user's hand 200 grasping the handgrip portion 108. The user's little finger 202, ring finger 204, and middle finger 206 are curled around a portion of the neck 106 that is oriented toward the discharge direction 130, with the thumb 208 completing the user's grip around a portion of the neck oriented away from the dispensing direction. The user's index finger 210 is left free to operate the trigger 122. Alternatively, the user may choose to place both the middle finger 206 and the index finger 210 on the trigger 122 to allow the trigger to be operated with more force than would be provided by single finger operation.

The downwardly angled discharge direction 130 allows the container 100 to be grasped by the user's hand 200 in the generally upright orientation, while the nozzle discharges liquid onto a target such as a weed 212. Under these conditions the user's wrist 214 is held in a generally comfortable condition for operating the trigger 122 to discharge the liquid in the discharge direction 130 and a center of mass 216 of the liquid in the reservoir 104 is located generally vertically below the user's hand 200. Advantageously, configuring the body 102, sprayer 120, and the neck 106 such that the location of the center of mass 216 is below the user's hand prevents the mass of the liquid in the reservoir 104 from exerting a torque on the user's wrist 214 during operation of the container 100 in the upright operating condition. Furthermore, in embodiments where the neck 106 is angled forwardly (i.e. by the angle β as shown in FIG. 2), the handgrip portion 108 when grasped by the user places the wrist 214 in a neutral condition (i.e. not cocked up or down) for dispensing liquid. Generally, the optimal neck angle β may be specific to a particular application, such as dispensing herbicide onto weeds.

Referring to FIG. 4, when it is desired to dispense liquid on a weed 240 that is located closer to the user, the user's wrist 214 may be slightly cocked angling the sprayer 120 slightly forward to aim the discharge direction 130 toward the weed 240. Under these conditions the center of mass 216 is displaced rearwardly to a new center of mass location 242 resulting in a torque in the direction indicated by arrow 244 bearing on the user's wrist 214. The user thus needs to exert an opposing torque at the wrist 214 to aim the discharge direction 130 toward the weed 240. Advantageously, under the operating conditions shown in FIG. 4, the downwardly oriented discharge direction 130 reduces the torque 244 required to aim the discharge direction.

Similarly, when it is desired to dispense liquid on a weed that is located further away from the user than the weed 212, the user's wrist 214 may be cocked to angle the sprayer 120 slightly backward from the upright condition to aim the discharge direction 130 accordingly.

In contrast, conventional containers having a dispensing direction oriented horizontally or even upwardly would require the wrist 214 to be cocked downwardly by a greater degree to aim the liquid toward the weed 240 shown in FIG. 4. Furthermore, when aiming toward the weed 212, such a container would also require the wrist 214 to be cocked somewhat downwardly resulting in a torque being exerted on the user's wrist under the same conditions shown in FIG. 3.

The inventors have discovered that a discharge angle α of in the range of about 10° to about 30° reduces the torque experienced at the user's wrist 214 when dispensing liquids onto a target object such as a weed that is generally located below the user's hand 200. Users may adopt various postures when dispensing liquid from the container. For example, some users may carry the container at waist height without stooping such that the container is located about 0.6 m to about 0.9 m above the ground. Other users may prefer to stoop or even kneel down when dispensing the liquid. The discharge angle α may be selected for use in a determined predominant user posture, while still providing a comfortable grip and wrist orientation for users assuming other postures. The inventors have further discovered that a discharge angle α in the range of about 15° and to about 25° is generally well suited for most users in dispensing herbicide on target weeds in multiple postures (e.g. standing upright, kneeling, sitting or crouching). Since it is commercially desirable to produce a single container for a particular product, the inventors have further discovered based on field trials that an discharge angle α of about 20° is generally well suited for operation by a wide range of different users in any of the various postures described above.

If the discharge angle α is made too small, the benefits of reduced torque on the wrist 214 are lessened, while too large a discharge angle α may produce a torque on the wrist in an opposite direction to the torque 244 making it necessary to angle the container upwardly to aim toward targets. Furthermore, it was discovered that neck angles β of greater than about 30° were found to cause weakening of the container 100 in a region where the neck 106 joins the body 102. Such containers, when packed in layers in a shipping crate, tended become deformed due to this weakness. A neck angle β of greater than about 30° may also result in kinking of the intake tube 126 due to the increased curvature required to place the inlet end 127 as shown in FIG. 2. Furthermore, if the neck angle β is greater than about 30°, machines for filling the container 100 may require modification to accommodate the angled neck, as standard filling machines may not be able to accommodate such a large neck angle.

Referring back to FIG. 1, in some embodiments the container 100 may be packaged and shipped as a refill container, thus facilitating reuse of a retained sprayer 120 from a previously purchased container. In such circumstances, the opening 118 would be sealed by a cap or other closure (not shown) and the user would remove the closure and insert the retained sprayer 120 into the opening 118 prior to use.

Referring back to FIG. 2, in the embodiment shown the intake tube 126 comprises a flexible tube having a length selected to cause the inlet end 127 of the tube to be forced forwardly in the reservoir 104 toward the discharge direction 130 such that when the container 100 is tilted forward from the generally upright condition, the inlet end of the tube is disposed to draw liquid from a low point in the reservoir. When the sprayer 120 is initially received in the opening 118, the inlet end 127 is forced forwardly toward an intersection between the base 110 and the wall 116. In operation, when the container is tilted forward as shown in FIG. 4, the inlet end 127 of the tube is disposed to draw liquid from a low point in the reservoir 104. Advantageously, when disposed as shown in FIG. 2, the inlet end 127 of the intake tube 126 is able to draw up substantially the entire liquid contents of the reservoir 104, even when the container is tilted forward. In many prior art containers, a portion of the liquid contents often remains unused after the inlet end of the tube becomes exposed to air in the reservoir, particularly when it is required to tilt the container while dispensing the liquid. The inventors have discovered that a tube having a length at least about 10% longer than the dimension between the distal end 121 of the neck 106 and the base 110 was sufficient to force the inlet end 127 into the location shown in FIG. 2. In one specific embodiment, the dimension between distal end 121 of the neck 106 and the base 110 was 21 cm, and the length of the intake tube 126 was about 23 cm.

The handgrip portion 108 also includes a protrusion 146, which is oriented outwardly toward the discharge direction 130. The protrusion 146 is disposed to cause the user's little finger 202 and ring finger 204 (as shown in FIG. 3) to be located below the protrusion between the reservoir 104 and the protrusion when grasping the container 100. Advantageously, the protrusion 146 prevents the container 100 from slipping downwardly in the user's hand 200, particularly when both the middle finger 206 and index finger 210 are both used to actuate the trigger 122. Under these conditions weight of the container 100 is supported only by the little finger 202, ring finger 204 and thumb encircling the handgrip portion 108.

The handgrip portion 108 also includes at least one surface having a plurality of relief features 148. As best shown in FIG. 1, in this embodiment the relief features 148 are in the form of raised features representing blades of grass. The actual form of the relief features 148 is selected mostly for aesthetic appeal, however the relief features also function to increase friction between the user's hand and the handgrip portion 108 resulting in a more secure grip of the container 100 by the user. Furthermore the relief features 148 also define a plurality of recesses 150, which permit at least a portion on the hand to be exposed to entrained air in-between the recesses thus providing some cooling of the hand while grasping the handgrip portion 108. Advantageously, the user's hand grasping the handgrip portion 108 has less tendency to perspire in the presence of the entrained air in the recesses 150, thus providing a more comfortable grip.

In the embodiment shown, the relief features 148 are disposed only on side surfaces, while a front surface 152 oriented toward the dispensing direction and a rear surface 154 oriented away from the dispensing direction have a generally smooth finish. In other embodiments the relief features 148 may be also disposed on the front surface 152 and the rear surface 154. While in this embodiment the relief features 148 comprise raised features, in other embodiments the relief features may be recessed with respect to a surface of the handgrip portion, in which case the recessed relief features entrain air when grasped by the user's hand.

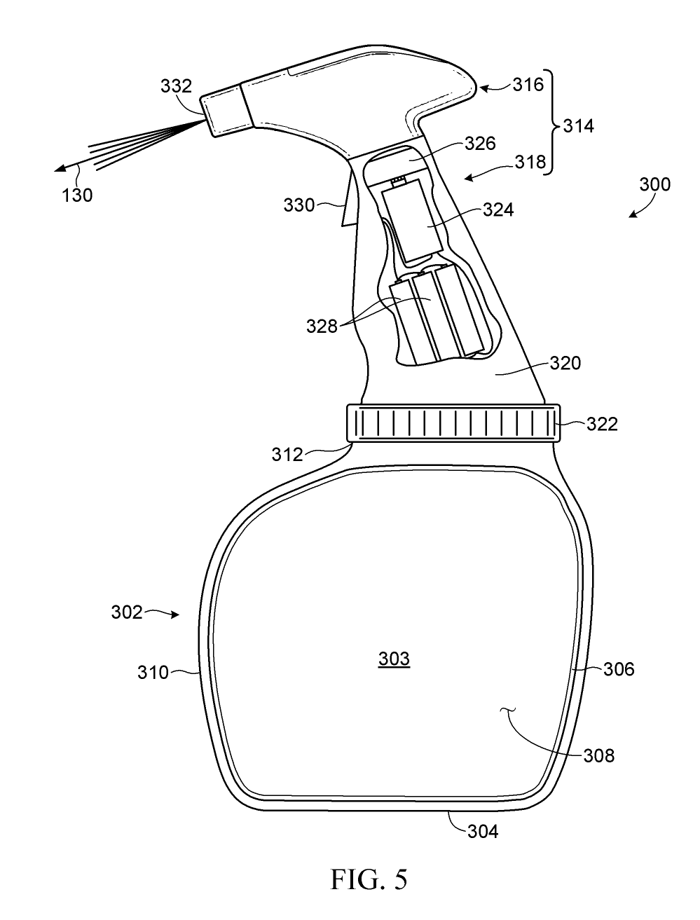

Referring to FIG. 5, an alternative embodiment of a container apparatus is shown generally at 300. The container 300 includes a body 302, having a base 304 and upwardly extending walls (of which walls 306, 308, and 310 are visible in FIG. 6). The walls 306, 308, and 310 form an opening 312 for receiving a sprayer 314. In this embodiment the sprayer 314 includes a sprayer head 316 and a neck 318 which are joined or integrally formed. The neck 318 defines a handgrip portion 320, which is shaped to receive a user's hand as described above. In this embodiment the relief features described above in connection with FIG. 1 are omitted from the handgrip portion 320 of the neck 318, and the handgrip has a generally smooth surface. The sprayer 314 also includes a threaded ring 322 for removably securing the sprayer 314 to opening 312 in the body 302.

In this embodiment, the sprayer 314 is electrically actuated. The sprayer 314 includes an electrical motor 324 mechanically coupled to a pump 326. Electrical power for operating the motor 324 is supplied by a plurality of batteries 328 via a switch 330. When the switch 330 is activated, the motor 324 operates the pump 326 and causes liquid to be drawn up from the reservoir 303 and expelled through a nozzle 332. The electrically actuated sprayer 314 reduces fatigue associated with extended manual operation of the trigger 122 (shown in FIG. 2). Alternatively, in the embodiment shown the sprayer head 316 may also be implemented using a manual sprayer as shown at 120 in FIG. 2.

Advantageously, the above described embodiments of the invention provide a container 100 that is comfortable to operate for extended periods of time. Various aspects of the invention address sources of fatigue on the user's hand that would otherwise limit the time for which the container 100 could be comfortably operated by the user.

While specific embodiments of the invention have been described and illustrated, such embodiments should be considered illustrative of the invention only and not as limiting the invention as construed in accordance with the accompanying claims.

What is claimed is:

1. A container apparatus for dispensing liquids, the apparatus comprising:
a body defining a reservoir for holding a liquid;
a neck extending outwardly from the body and providing a handgrip portion, which when grasped by a user's hand such that the reservoir is disposed generally below the user's hand, defines an upright operating condition for the container; and
a sprayer disposed at a distal end of the neck, the sprayer having an intake and a nozzle, the intake being in communication with the reservoir for drawing liquid from the reservoir, the nozzle being disposed such that when the container is oriented in the upright operating condition, liquid is discharged from the nozzle in a discharge direction oriented downwardly at a discharge angle of in the range of about 10 degrees to about 30 degrees to a notional horizontal line extending outwardly from the nozzle.

2. The apparatus of claim 1 wherein the distal end of the neck is angled forward sufficiently toward the discharge direction to cause the nozzle to be disposed to discharge liquid in the discharge direction when the container is oriented in the upright operating condition.

3. The apparatus of claim 1 wherein the neck forms an opening at the distal end of the neck for removably receiving the sprayer.

4. The apparatus of claim 1 wherein the body forms an opening for removably receiving the neck.

5. The apparatus of claim 1 wherein the body comprises a base and a plurality of walls extending upwardly from the base, and wherein the base is substantially horizontally oriented when the container is oriented in the upright operating condition.

6. The apparatus of claim 1 wherein the discharge angle is in the range of about 20 degrees.

7. The apparatus of claim 1 wherein the discharge angle is in the range of about 15 degrees to about 25 degrees.

8. The apparatus of claim 1 wherein the sprayer comprises a reciprocating piston pump coupled to a manual trigger actuator, the actuator being operable to cause the pump to expel liquid through the nozzle when the actuator is depressed and to draw liquid from the reservoir when the actuator is released.

9. The apparatus of claim 1 wherein the sprayer comprises an electrical pump operably configured to cause liquid to be drawn up from the reservoir and expelled through the nozzle when actuated.

10. The apparatus of claim 1 wherein the neck defines a conduit extending between the sprayer and the body and wherein the intake of the sprayer comprises a tube extending through the conduit and terminating in an inlet end in communication with the reservoir.

11. The apparatus of claim 10 wherein the tube comprises a flexible tube having a length selected to cause the inlet end of the tube to be forced forwardly in the reservoir toward the dispensing direction such that when the container is tilted forward from the generally upright condition, the inlet end of the tube is disposed to draw liquid from a low point in the reservoir.

12. The apparatus of claim 11 wherein the body comprises a base and a plurality of walls extending upwardly from the base and wherein the length of the tube is at least about 10% longer than a minimum dimension between the sprayer and the base.

13. The apparatus of claim 10 wherein the body comprises a base and a plurality of walls extending upwardly from the base and wherein the inlet end of the tube is disposed proximate an intersection between the base and a wall defining a side of the container oriented toward the dispensing direction.

14. The apparatus of claim 1 wherein the handgrip portion extends upwardly from a location on the body that is disposed to cause a center of mass of the liquid in the reservoir to be located generally vertically below the user's hand thereby preventing the mass of the liquid in the reservoir from exerting a torque on the user's wrist during operation in the upright operating condition and reducing the torque exerted on the user's wrist when the wrist is cocked to aim the discharge direction toward or away from the user.

15. The apparatus of claim 1 wherein the neck includes a protrusion oriented in the dispensing direction and disposed to cause a little finger and ring finger of the user to be located generally between the body and the protrusion when grasping the handgrip portion of the neck.

16. The apparatus of claim 1 wherein the neck comprises at least one surface having a plurality of relief features extending over at least a portion of the handgrip portion.

17. The apparatus of claim 16 wherein the relief features are formed by a plurality of raised features.

18. The apparatus of claim 16 wherein the relief features are formed by a plurality of recessed features.

19. A container comprising:
a body defining a reservoir for holding a liquid;
a neck extending outwardly from the body and providing a handgrip portion, which when grasped by a user's hand such that the reservoir is disposed generally below the user's hand, defines an upright operating condition for the container;
the neck forming an opening at a distal end of the neck for receiving a sprayer, the sprayer having an intake and a nozzle such that when the nozzle is received in the opening, the intake is disposed in communication with the reservoir for drawing liquid from the reservoir, and when the container is oriented in the upright operating condition the nozzle is disposed such that liquid is discharged from the nozzle in a discharge direction oriented downwardly at a discharge angle of in the range of about 10 degrees to about 30 degrees to a notional horizontal line extending outwardly from the nozzle.
